(19) United States
(12) Patent Application Publication
(10) Pub. No.: US 2021/0027329 A1
(43) Pub. Date: Jan. 28, 2021

(54) Kids' Loyalty and Rewards Program

(71) Applicant: B. Little & Company, Inc., New York, NY (US)

(72) Inventors: Katherine G. VOSTERS, New York, NY (US); Paul A. LEAKAS, New York, NY (US)

(73) Assignee: B. Little & Company, Inc., New York, NY (US)

(21) Appl. No.: 15/777,571

(22) PCT Filed: Nov. 17, 2016
(86) PCT No.: PCT/US16/62399

§ 371 Date: May 18, 2018

Related U.S. Application Data
(63) Continuation of application No. 14/947,415, filed on Nov. 20, 2015, now abandoned.
Application No. 14/947,415 is a continuation-in-part of application No. PCT/US2015/039738, filed on Jul. 9, 2015.
(60) Provisional application No. 62/025,232, filed on Jul. 16, 2014.

(51) Int. Cl. G06Q 30/02; G06Q 20/34; G06Q 20/38

(52) U.S. Cl. CPC G06Q 30/0233; G06Q 30/02; G06Q 20/387; G06Q 20/342; G06Q 30/0207

(57) ABSTRACT

The present disclosure relates generally to vendor loyalty and reward programs. The programs generally comprise purchasing a qualified item from a participating vendor, obtaining a loyalty card comprising a code, entering the code to obtain a value that may be redeemed for a reward. More specifically, the disclosure relates to vendor loyalty and reward programs targeting younger customers in the context of food purchases.

### CROSS REFERENCE TO RELATED APPLICATIONS

This application claims priority to U.S. patent application Ser. No. 14/947,415, filed Nov. 20, 2015, the entirety of which is hereby incorporated by reference.

### FIELD

The present disclosures relate to vendor loyalty and reward programs. More specifically, the present disclosures relate to vendor loyalty and reward programs targeting younger customers in the context of food purchases.

### BACKGROUND

It is very important for businesses to come up with innovative ways to attract new customers as well as maintain the loyalty of existing customers. Products are routinely promoted to customers by offering the possibility of winning a prize through sweepstakes or through promotional/incentive offers. Prepaid gift cards and reward programs are additional examples of marketing tools commonly used to increase sales and customer loyalty. Increasingly, companies have been targeting children as a way to increase profits. However, because children are more impressionable, it is difficult for a single company to establish a child's loyalty and develop a long term relationship.

In the United States alone, children spend approximately $200 billion dollars annually, the majority of which is related to food products. Further, studies have shown that children's demands have a significant impact on the purchasing patterns of their parents. Accordingly, approximately $14 billion is spent each year in North America on marketing campaigns targeting children. Recently, food and beverage products aimed at children have increased in number and variety; however, these products tend to be high in calories, sugars, salt, and fats as well as being low in nutrients. The World Health Organization (“WHO”) has identified a correlation between marketing of unhealthy food products and the increasing obesity epidemic. According to the WHO, obesity rates in children has tripled in the last thirty years alone. Even more startling, the WHO estimated in 2006 that there were already 17.6 million children globally under the age of 5 considered as overweight. In the United States alone, researchers estimate that 16.9 percent of children ages 2 to 9 are obese, and 31.7 percent are overweight. This translates to more than 12 million children and adolescents who are obese, and more than 23 million who are overweight. Further, medical costs for treating obesity-related conditions exceeds $150 billion annually.

With the growing epidemic of childhood obesity and diabetes, there exists a need in the art to incentivize healthier food options for youths and to develop a long term relationship between a child and a vendor offering healthier food options.

### SUMMARY

A loyalty and rewards program according to the present disclosure may encourage youths to purchase healthier food options having reduced calories, lower trans and saturated fats, lower cholesterol, lower sodium, higher fiber, or a combination thereof, when compared to non-qualified food options.

In one aspect, a customer may receive a reward code on a paper/plastic loyalty card, packaging, receipt, electronically or some other means each time the customer purchases a qualified kid meal or healthier food option. The reward code may be unique. In such an aspect, a customer may then enter into a website to create an online user account. In an aspect, a customer may log into their online user account and enter one or more reward codes associated with the loyalty card. Each reward code may represent an intrinsic value of points, dollar amount, or virtual currency which may be accrued in the customer's online user account. In a further aspect, the intrinsic value of points, dollar amounts, or virtual currency accrued in a customer's online account may be redeemed to acquire one or more items such as a gift card or a prize from an online redemption center.

In another aspect, a customer may capture an image of a merchant receipt(s) and submit the image(s) for validation by logging into a user account and uploading such image(s) through a web portal after the customer purchases a qualified kid meal or healthier food option. The image(s) may be converted into machine-encoded text by optical character recognition (“OCR”) technology. The OCR conversion may be completed by a user prior to uploading or by the reward program following uploading of the image(s). Specific identifiers on the receipt may represent an intrinsic value of points, dollar amount, or virtual currency which may be accrued in the customer's online user account. In some other embodiments, an image may be captured by a smart phone, tablet computer, or other mobile device that downloads an application configured to access the web portal. Capturing an image may include taking a picture, scanning, or other means known in the art capture visual information.

In another aspect, a customer may add value to an online user account by logging into a user account through a mobile application and scanning merchant receipt(s). The mobile application may process scanned receipt(s) for all participating qualifying reward products, date of transaction, type of payment (for example cash, debit, credit, gift card, or the like) and/or any other eligibility requirements to validate and award respective value(s) for each qualifying product purchase with value(s) as set by the reward program. The mobile application may convert the image(s) into machine-encoded text by optical character using OCR technology. The value may be in the form of points, virtual currency, or a dollar amount. In a further aspect, the intrinsic value of points, dollar amounts, or virtual currency accrued in a customer's online account may be redeemed to acquire one or more items such as a gift card or a prize from an online redemption center.

### BRIEF DESCRIPTION OF THE DRAWINGS

FIG. 1 shows the front and back sides of a sample reward card according to an aspect of the present disclosure.

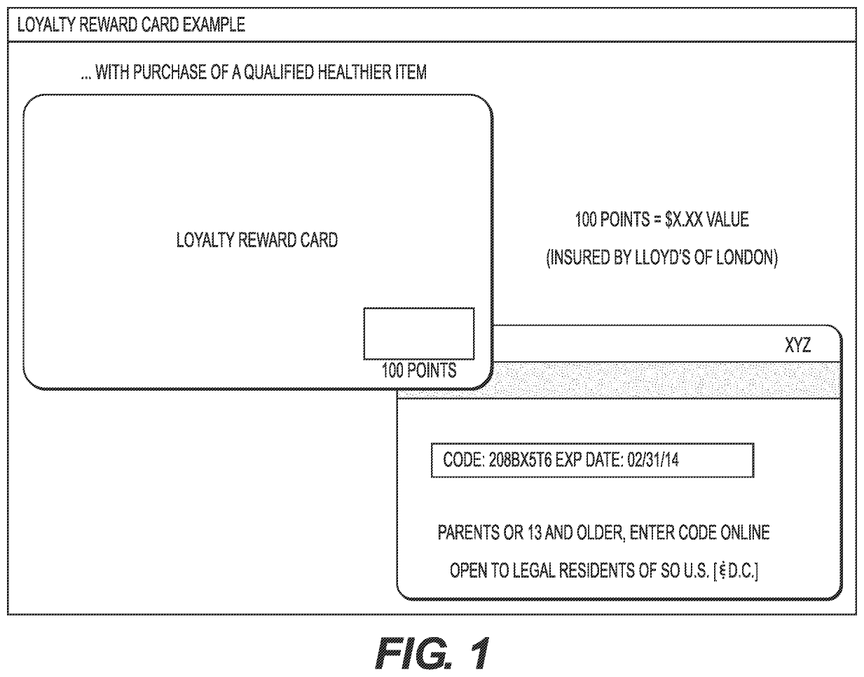

FIG. 2 shows a screen capture of an exemplary online redemption center according to an aspect of the present disclosure.

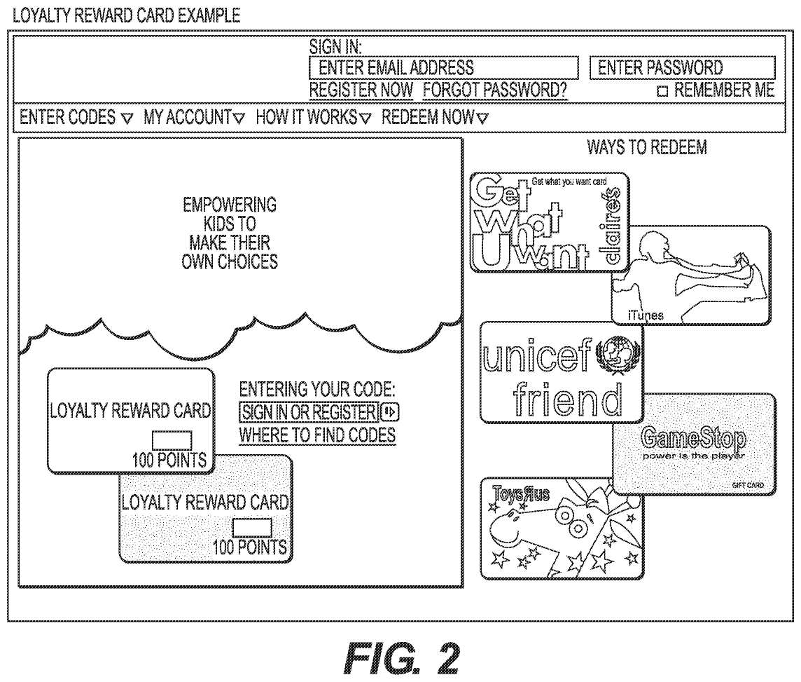

FIG. 3 shows a summary of a loyalty program according to an aspect of the present disclosure.

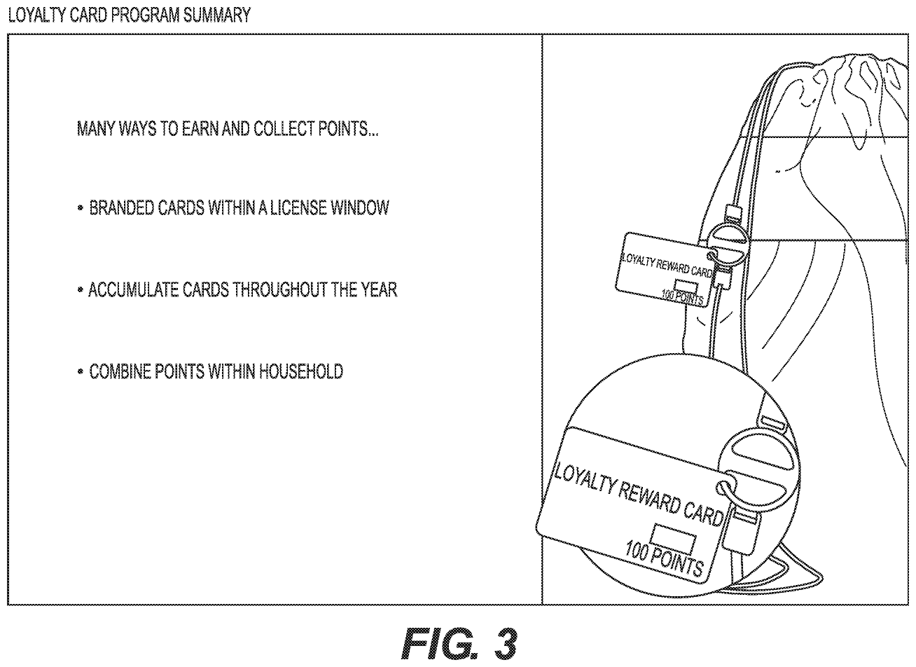

FIG. 4 is a flow chart of a loyalty program according to an aspect of the present disclosure.

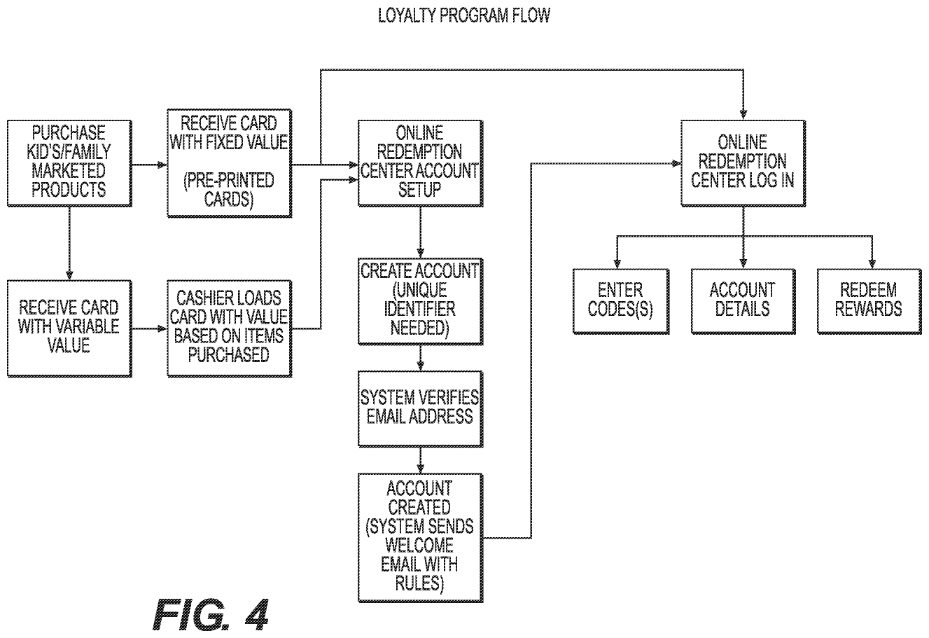

FIG. 5 is a flow chart of an online redemption center user account set-up according to an aspect of the present disclosure.

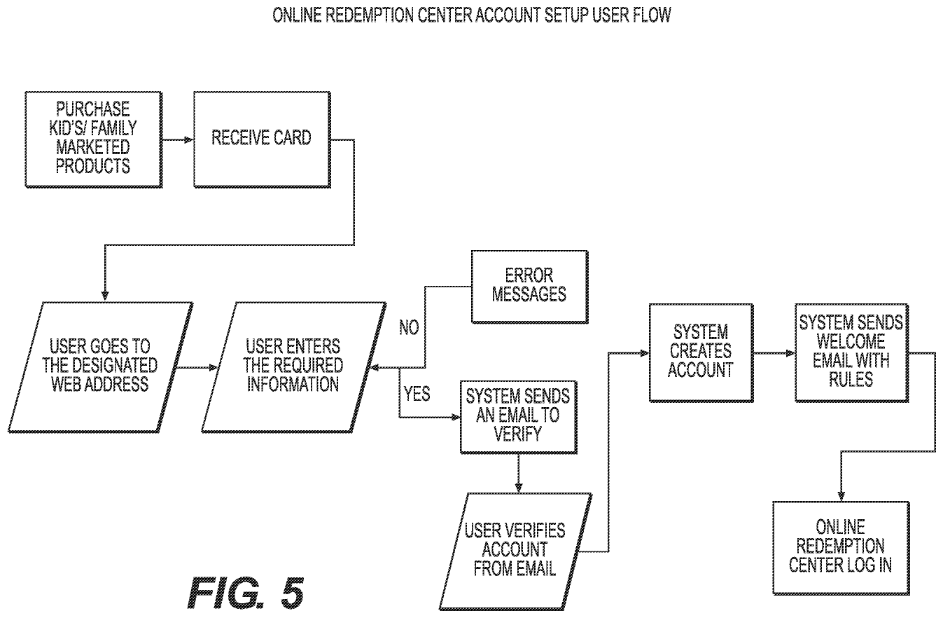

FIG. 6 is a flow chart of options available at an online redemption center according to an aspect of the present disclosure.

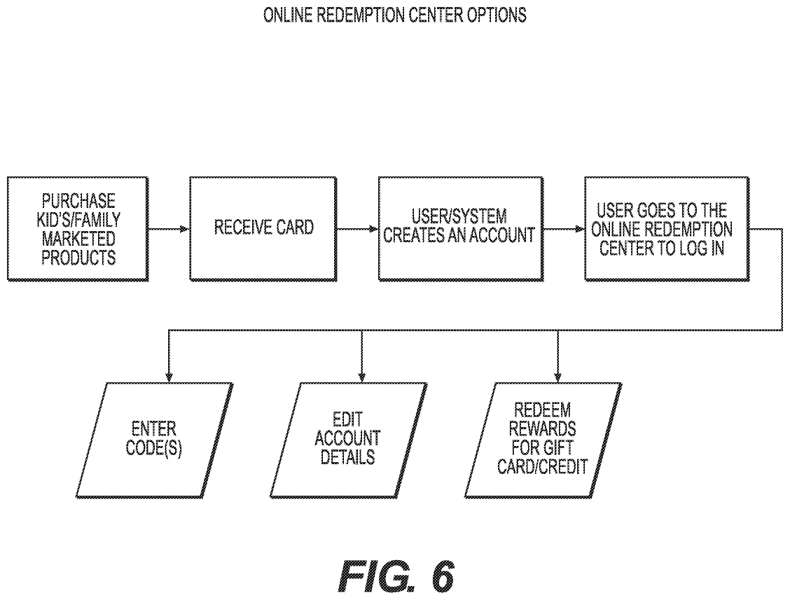

FIG. 7 is a flow chart of options available at an online redemption center according to an aspect of the present disclosure.

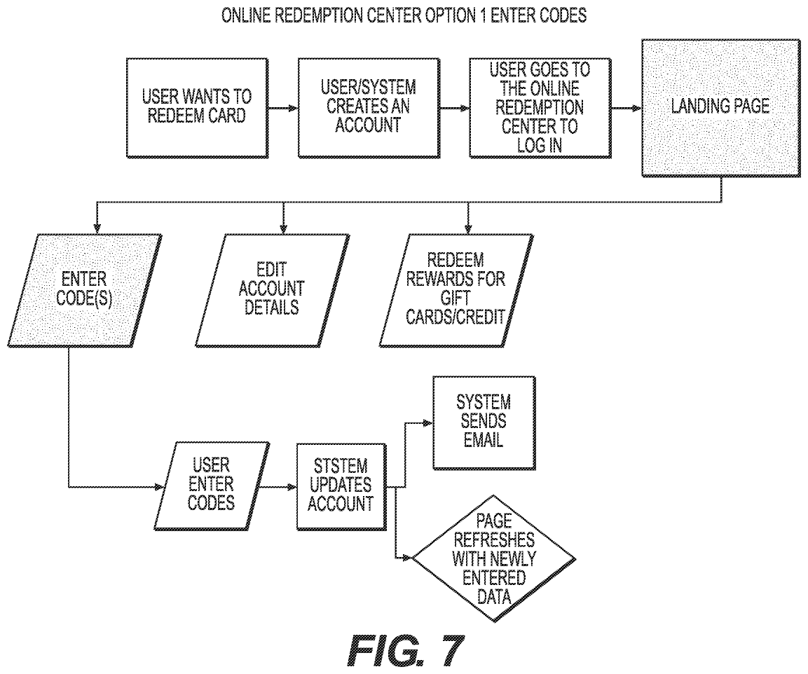

FIG. 8 is a flow chart of options available at an online redemption center according to an aspect of the present disclosure.

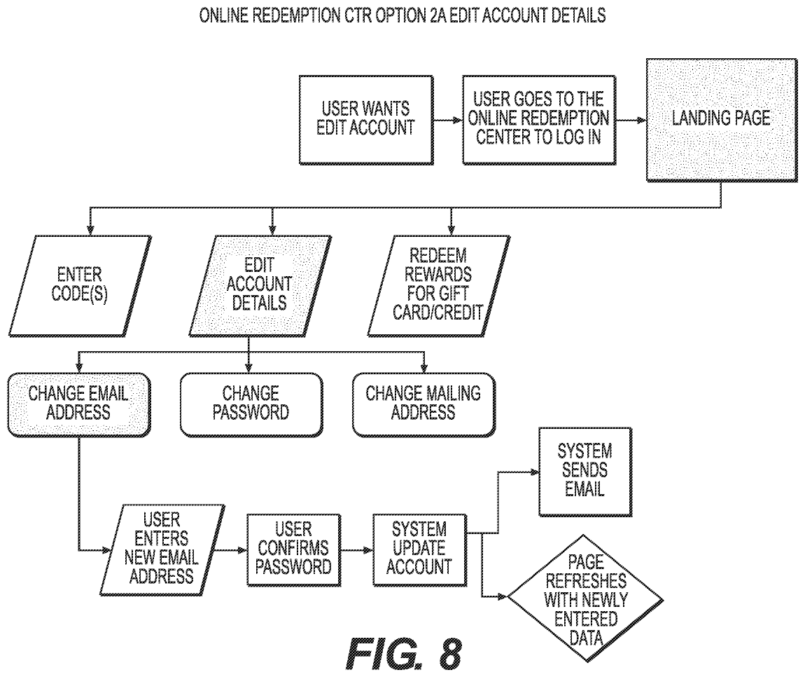

FIG. 9 is a flow chart of options available at an online redemption center according to an aspect of the present disclosure.

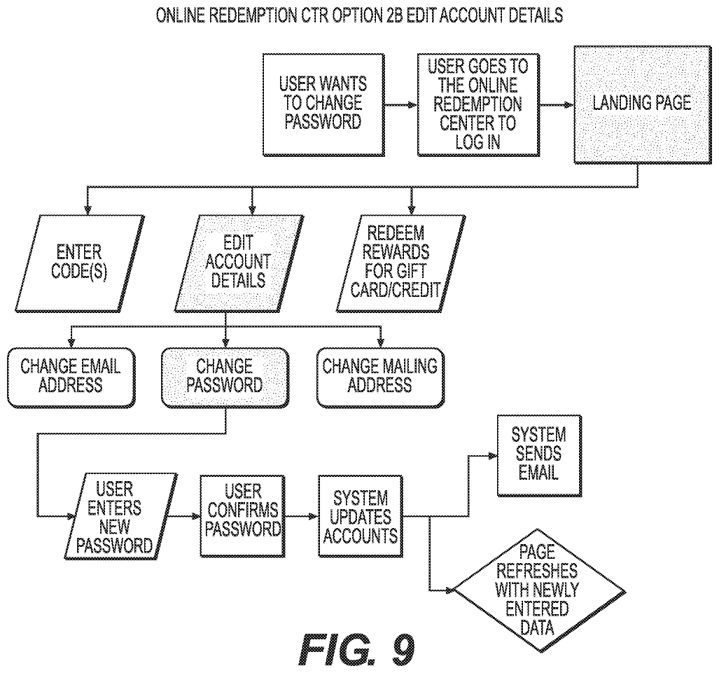

FIG. 10 is a flow chart of options available at an online redemption center according to an aspect of the present disclosure.

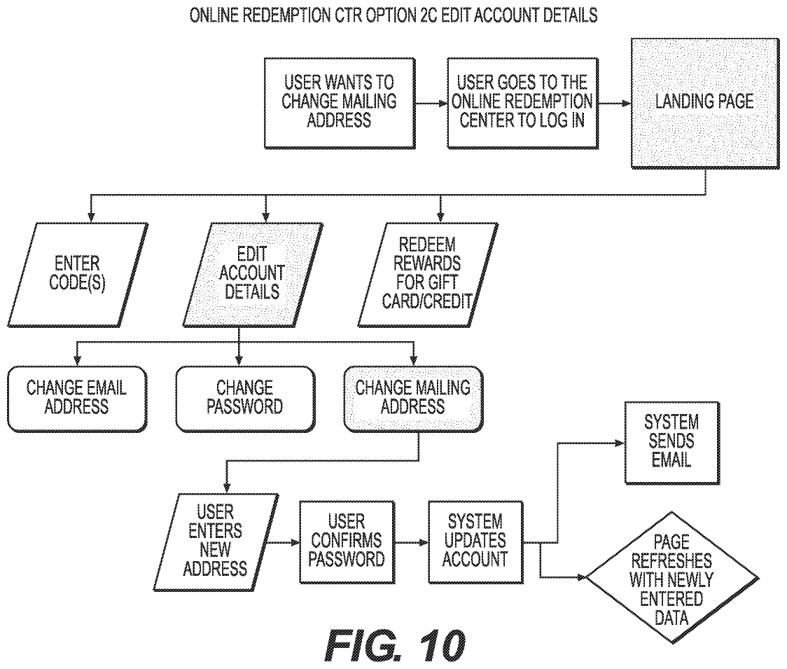

FIG. 11 is a flow chart of options available at an online redemption center according to an aspect of the present disclosure.

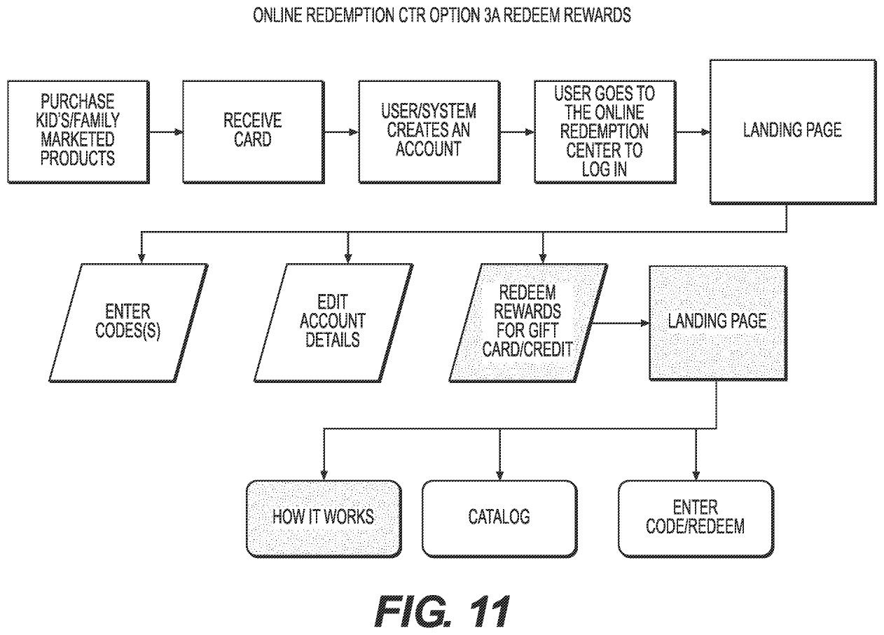

FIG. 12 is a flow chart of options available at an online redemption center according to an aspect of the present disclosure.

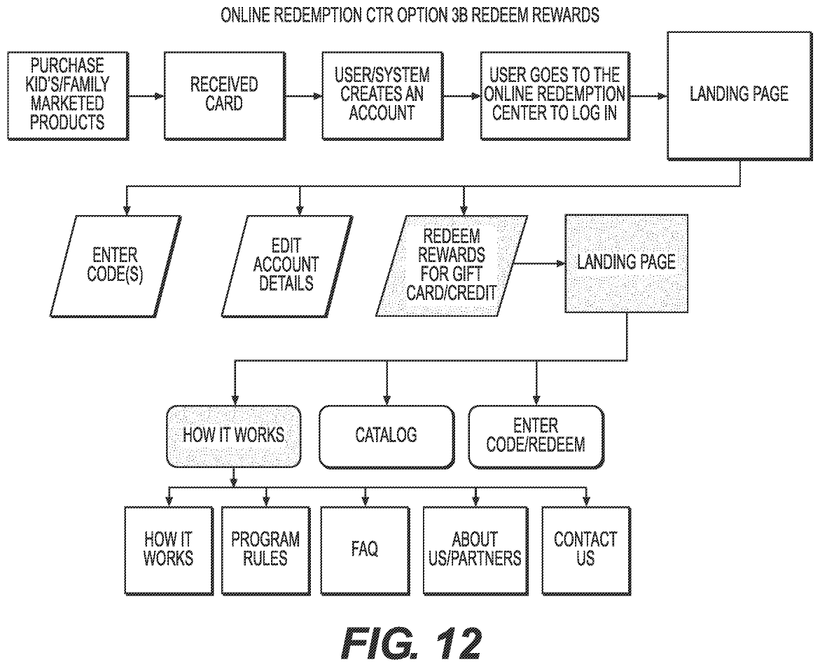

FIG. 13 is a flow chart of options available at an online redemption center according to an aspect of the present disclosure.

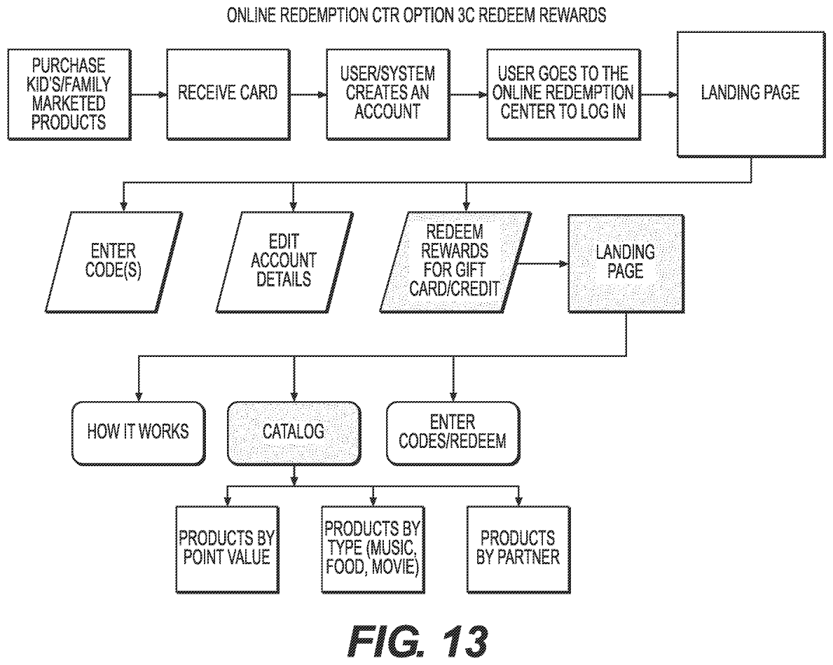

### DETAILED DESCRIPTION

As described above, the present disclosures provide for and include a loyalty and reward program that may encourage youths to purchase healthier food options having reduced calories, lower trans fats, lower saturated fats, lower cholesterol, lower sodium, higher dietary fiber, or a combination thereof, when compared to non-qualified food options. According to the present disclosure, a child may receive one or more loyalty cards upon purchasing one or more marketed products from a participating vendor. Alternatively, a child may capture an image of vendor receipt(s) or scan vendor receipts using a mobile application. The participating vendor may be a consumer packaged goods company, a grocery store, a convenience store, a department store, a market, a supermarket, a deli, a delicatessen, a produce market, a greengrocer, a restaurant, a fast-food restaurant, a food truck, or the like. The child may use information provided by the loyalty card or receipt to access an online reward system through a website. The card or receipt may include a code, which may allow the child to accumulate virtual currency that can be used to redeem a gift card or a prize through an online redemption center from a merchant.

In one aspect, the present disclosure provides a system for incentivizing a customer to purchase a healthier food item comprising a database for storing customer accounts and accumulated account value; and a web portal allowing customers to access and update accounts. The system may further include providing one or more loyalty cards or receipts upon purchasing participating qualifying products, such as a healthy food option. The method may further comprise visiting an online redemption site to redeem accumulated points, virtual currency, or a dollar amount for a reward. The online redemption site may be accessed through the web portal. Further, the loyalty cards or receipts may comprise a reward code or other information that corresponds to an amount of points, virtual currency, or a dollar amount. The online redemption center may provide an online catalog of rewards that may be redeemed by the customer with accumulated points, virtual currency, or dollar amount. The reward redeemed may be a gift card or a prize. In some aspects, the gift card may be a prepaid credit card or a prepaid debit card.

In one aspect, the present disclosure provides for a method of acquiring value in a loyalty program comprising purchasing a qualified item from a participating vendor, obtaining a receipt or one or more loyalty cards comprising a reward code, creating an online user account, accessing the online user account, and uploading a captured image of the receipt or entering the reward code. The value may be in the form of points, virtual currency, or a dollar amount. The qualified item may be a healthier food option. The method may further comprise presenting a reward card to a cashier upon purchasing a qualified healthier food choice, obtaining a second reward code upon the presenting, and redeeming the first or the second reward code at an online loyalty program, where the redeeming may result in the addition of a value to an online account registered to an owner of the reward card. The accumulated user account value may expire after remaining a constant value for a set number of days determined by the owner of the reward program. The accumulated user account value may expire after remaining a constant value for at least a week, at least a month, at least 2 months, at least 3 months, at least 4 months, at least 5 months, at least 6 months, or at least a year. The accumulated user account value may expire after remaining a constant value for at least 30, 45, 60, 75, 90, or 120 days.

In one aspect, the present disclosure provides for and includes a method of redeeming a loyalty account value for a reward including logging into a user account; accessing an online redemption center; and selecting a reward, where the user account and the online redemption center are associated with a loyalty program. The reward may be a prepaid gift card, virtual card, store credit, coupon, or the like. The method may comprise trading the accumulated points, virtual currency, or dollar amount for a gift card or a prize. In one aspect, the gift card may be a virtual card. In another aspect, the prize card may be a prepaid gift card for ITUNES®, GAMESTOP®, TOYSRUS®, or another store.

In one aspect, the present disclosure provides for and includes a method of incentivizing a customer to purchase a healthier food item including assessing whether a food item selected by the customer is a qualifying healthier food item; determining a value to be associated with the healthier food item, where the value is higher for qualifying healthier food items and lower for non-qualified healthier food items; and providing a receipt or one or more loyalty cards to the customer, where the loyalty cards are collectively assigned the value associated with the food item. The method of incentivizing a customer to purchase a healthier food item may further include authenticating the customer via a web portal, receiving as an input to the web portal the associated value from a receipt or one or more loyalty cards, adding each received associated value to an account associated with the authenticated customer, and storing in a computer database the account associated with the authenticated customer. The method may influence children to choose healthier food options.

In a first step according to the present disclosure, a customer may receive a reward code on a paper/plastic loyalty card or other method upon purchasing a qualified item. The qualified item may be a food product. The food product may be a kid meal or healthier food option. The rewards code may comprise numbers, letters, or both numbers and letters. The code may be alpha-numeric. The code may be a symbol or barcode. The reward code may be unique. The reward code may expire prior to entering into an online user account. In one embodiment, the purchasing may be done by a parent, sibling, or guardian. The loyalty card may be obtained by purchasing a qualified item from a restaurant, grocery store, market, convenience store, or the like. In some aspects, a child may first sign up for an online reward program and receive a membership identification number. A member may be required to present a membership identification number to a vendor to receive a loyalty card.

In some aspects of the present disclosure, the loyalty card may be a card formed of stiff paper or chipboard in the traditional sense, or a rigid or semi rigid plastic or other substrate, or may be a slip of paper, booklet, or it may be the back or inside of the label or box or a portion of the outside of the label box, drinking vessel such as a juice or water bottle, packaging, all of which are considered a card for purposes of the present disclosure. The loyalty card may be preprinted with text instructions the customer may use to access a web portal, create a loyalty account and upload a reward code. In certain embodiments, the customer may be instructed to access the web portal by visiting a particular website through his or her standard browser. In other embodiments, the loyalty card may provide instructions to the customer to download a program or an application (e.g., a mobile app) configured to access the web portal in order to set up a loyalty account. In still other embodiments, the loyalty card may provide a code that can be scanned by a smart phone, tablet computer, or other mobile device that downloads an application configured to access the web portal. Further, in certain embodiments the loyalty card may depict a reward code in alphanumeric characters. In other embodiments, the reward code could take the form of a scannable code, such as a “Q” code or a bar code. It will be understood that the foregoing examples of how the web portal may be accessed, and the format of the reward code, are merely exemplary; the account creation and reward code information on the card, in whatever form it takes, is available to the customer who has the card, or the parent, sibling, or guardian of the customer. The card may be provided on the product package in such a way as to only be available to the purchaser after the product is purchased (such as, for example, in a “scratch-off” format). The loyalty card may be given by a cashier after the purchase of a qualified item.

In some aspects of the present disclosure, participating qualifying reward products may be identified by consumers through advertising, in-store marketing, packaging or other communication methods without issuance of a reward code. A customer may add value to an online user account for purchases of participating qualifying products by capturing an image of merchant receipt(s) and submitting the receipt(s) for validation by logging into a user account and uploading such image(s) through a web portal. The image(s) may be converted into machine-encoded text by optical character recognition (“OCR”) technology. The OCR conversion may be completed by a user or by the reward program following uploading of the image(s) of the receipts(s). A receipt may contain a barcode. A barcode, if present, may be a one-dimensional barcode. A barcode, if present, may be a two-dimensional barcode, such as a Quick Response (“QR”) code. The online reward system may process receipt(s) for all participating qualifying reward products, date of transaction and/or any other eligibility requirements to validate and award respective value(s) for each qualifying product purchased with value(s) as set by the reward program. The value may be in the form of points, virtual currency, or a dollar amount. In some aspects, information on any non-participating product purchases may also be processed by system to identify consumer behaviors, shopping cart analysis, and/or other insights. In some other embodiments, an image may be captured by a smart phone, tablet computer, or other mobile device that downloads an application configured to access the web portal. Capturing an image may include taking a picture, scanning, or other means known in the art capture visual information.

In another aspect, a customer may add value to an online user account by logging into a user account through a mobile application and scanning merchant receipt(s). A receipt may contain a barcode. A barcode, if present, may be a one-dimensional barcode. A barcode, if present, may be a two-dimensional barcode, such as a Quick Response (“QR”) code. The mobile application may process scanned receipt(s) for all participating qualifying reward products, date of transaction, type of payment (for example cash, debit, credit, gift card, or the like) and/or any other eligibility requirements to validate and award respective value(s) for each qualifying product purchase with value(s) as set by the reward program. The value may be in the form of points, virtual currency, or a dollar amount. A value may be obtained by payment with a debit, credit, or gift card from a qualified partner. The mobile application may be configured to send periodic updates to an account holder's mobile device. Updates may provide an account balance and/or indicate how much future value needs to be accrued in order to be redeemed for a particular reward. In an aspect, a reward code may only be entered into the online reward system once. In some aspects, information on any non-participating product purchases may also be processed by a mobile application to identify consumer behaviors, shopping cart analysis, and/or other insights.

The web portal, whether in the form of a website, program, mobile app, etc., may be supported by the owner of the reward/incentive program. Alternatively, the web portal may be operated/supported by a third party. In some aspects, the online user account can only be set up using a reward code on a loyalty card. Alternatively, a parent, sibling, or guardian of the owner of a reward card may create a user account for the child. The child may visit an online reward system and create a username and password. The username may be unique to an individual customer. The username may be shared by multiple individuals. The user/child may use their username and password to log into their user account to enter reward codes, upload captured images of receipts, edit account details, or redeem points, virtual currency, or a dollar amount associated with the user's account for a reward. It may be possible for siblings in the same family to belong to the same user account and have access to the account.

In an aspect, once a user account is created, a user can log into an online loyalty program system using, for example, a website associated with the loyalty program, or the app that the user has previously downloaded. The online reward system may verify the email address associated with the user account. The owner of the user account may receive a welcome email providing the rules of the loyalty program. The online loyalty program system may comprise a redemption center. In an aspect, logging in to an online redemption center may direct a user to a landing page. The landing page can be used to redeem rewards for a gift or edit user/account details or information. The user may use the landing page to enter one or more reward codes. Alternatively, the user may use the landing page to upload captured images of receipts. In some aspects, once the reward code receipt information is entered into the reward system, the system may update the user account. The reward code may be typed in manually or scanned in using a smart phone, tablet computer, or other mobile device. In one aspect, images of receipts may be uploaded or scanned in using a smart phone, tablet computer, or other mobile device. Further, the web page may refresh upon entry of new information or a reward code and/or the online system may send the user an email notifying the user that the user account has been updated.

In an aspect, the user may log into their user account and go through a landing page to edit account details. In other embodiments, there may be an “edit account details” option in a mobile app. In any case, the user may change his or her email address, change his or her password, or change his or her mailing address. In addition, the user may confirm any changes to the account details using the user's password. In one aspect, the system may send the user an email to notify the user of the changes to the account detail or confirm the changes with the user.

In an aspect according to the present disclosure, a customer may join a loyalty program by purchasing a qualified item, obtaining a receipt or loyalty card, and creating an online user account. In some aspects, a customer may accumulate value through participating in the loyalty program that may be in the form of points, virtual currency, or a dollar amount with each receipt or loyalty card obtained. In many aspects, the value obtained may be determined by the qualified item purchased, the number of qualified items purchased, the regularity at which a qualified item is purchased, and/or the number of times a qualified item is purchased.

In one aspect, the receipt or loyalty card may have a variable value. By way of non-limiting example, a cashier may load the loyalty card with (or print on the receipt) a value based on the items purchased. In another aspect, the receipt or loyalty card may have a fixed value. By way of non-limiting example, a loyalty with a fixed value and reward code may be given to the customer by the cashier, where the cashier chooses the loyalty card having a fixed value based on the purchase of a qualified item. By way of non-limiting example, a customer who purchases a qualified kid meal including a juice or a low fat dairy option may receive a receipt or loyalty card having a higher fixed value than a customer who purchases a kid meal including a soda. The present disclosure may involve issuing a receipt or physical cards having a reward code which represents a value but are not attached to any customer until the card holder enters the information on the receipt or reward code into a web-based reward/loyalty system. The value accrued by a qualified purchase may be displayed on a receipt, the loyalty card, or both the receipt and loyalty card.

In some aspects of the method provided herein, the amount of value obtained may be related to the number of servings of fruit, vegetables, or fruit and vegetables per serving of the healthier food option. The value obtained may be related to the amount of calories per serving in said healthier food option. The value obtained may be related to the amount of sodium per serving in said healthier food option. In yet another aspect, the value obtained may be related to the amount of saturated fat, trans fat, cholesterol, or a combination thereof per serving in the healthier food option. The healthier food option may be a kid meal. A kid meal may have at least one fruit, or at least one vegetable per serving. In an aspect, a cashier may add a value to the reward card which depends on the amount and/or type of qualified items purchased. In a non-limiting example, a purchase of a low calorie, high fiber meal may be worth more points than a low calorie, low fiber meal.

In some aspects of the present disclosure, the healthier food option may contain less than 500, less than 400, or less than 300 calories per serving. The amount of value obtained may increase with decreasing caloric value.

In some aspects of the present disclosure, the healthier food option may contain less than 750 milligrams (mg), less than 640 mg, less than 600 mg, less than 500 mg, less than 400 mg, less than 300 mg, less than 200 mg, or less than 100 mg of sodium per serving. The amount of value obtained may be increased with decreasing amounts of sodium per serving.

In some aspects of the present disclosure, the healthier food option may contain less than 35% of the total calories coming from fat. In other aspects, less than 30%, less than 25%, less than 20%, or less than 15% of the calories come from fat.

In some aspects of the present disclosure, the healthier food option may contain less than 15 grams, less than 10 grams, less than 5 grams, or substantially no saturated fat. The amount of value obtained may increase with decreasing amounts of saturated fat per serving.

In some aspects of the present disclosure, the healthier food option may contain less than 100 mg, less than 75 mg, less than 50 mg, less than 10 mg, or substantially no cholesterol per serving. The amount of value obtained may increase with decreasing amounts of cholesterol per serving.

In some aspects of the present disclosure, the healthier food option may contain less than 1 mg trans fat. In another aspect, the healthier food option may contain less than 0.5 mg trans fat. In one aspect, the amount of value obtained may increase with decreasing amounts of trans fat per serving.

In some aspects of the present disclosure, the healthier food option may contain at least 2, 3, 4, 5, 6, 7, 8 or more grams of dietary fiber per serving. The amount of value obtained may increase with increasing amounts of dietary fiber per serving.

In some aspects of the present disclosure, the healthier food option may contain less than 65% calories from carbohydrates. The healthier food option may contain less than 60%, less than 55%, or less than 50% calories from carbohydrates.

In some aspects of the present disclosure, at least 50% of the carbohydrates in the healthier food option are complex carbohydrates. In other aspects, at least 60%, at least 70%, at least 80% or at least 90% of the carbohydrates in the healthier food option may be complex carbohydrates. In one aspect, 100% of the carbohydrates in the healthier food option may be complex carbohydrates. Complex carbohydrate sources may include whole-grain breads, granary breads, rye breads, high fiber cereal, oats, bran, muesli, cassava, pasta, potatoes with skin on, yams, starchy vegetables, peas, beans, lentils, and the like.

In some aspects of the present disclosure, the healthier food option may contain a low glycemic load. A healthier food option may have a glycemic load of less than 50 per serving. A healthier food option may have a glycemic load of less than 45, less than 40, less than 35, less than 30, less than 25, less than 20, or less than 15 per serving.

In some aspects of the present disclosure, the healthier food option may contain at least ¼ cup of vegetables. The healthier food option may contain at least ½, ¾, or a full cup of vegetables.

In some aspects of the present disclosure, the healthier food option may contain at least ¼ cup of fruit. The healthier food option may contain at least ½, ¾, or a full cup of fruit.

In some aspects of the present disclosure, the healthier food option may contain at least ¼ cup of legumes. The healthier food option may contain at least ½, ¾, or a full cup of legumes.

In some aspects of the present disclosure, the healthier food option may contain at least ½ serving of nuts and/or seeds.

In some aspects of the present disclosure, the healthier food option may contain at least 1, 2, 3 or more servings of whole grains. The healthier food option may contain at least 25, 50, 75, or 100 grams of whole grains.

In some aspects of the present disclosure, the healthier food option may contain less than 35% of the total calories coming from fat, less than 0.5 mg trans fat, and less than 640 mg sodium.

In some aspects of the present disclosure, the healthier food option may contain a low fat dairy option. The low fat dairy option may be low fat or fat-free chocolate milk. The low fat dairy option may be skim or fat-free milk. The low fat dairy option may be milk containing 1% milk fat, or 2% milk fat. The low-fat dairy option may be fat-free or low fat yogurt. The fat-free or low fat yogurt may be Greek yogurt. The low fat-dairy option may be fortified with vitamins and/or nutrients. The low fat-dairy option may be fortified with calcium and/or vitamin D. The low-fat dairy option may be cheese.

In some aspects of the present disclosure, the healthier food option may contain soy milk, rice milk, or almond milk. The soy milk, rice milk, or almond milk may be fortified with vitamins and/or nutrients.

In some aspects of the present disclosure, the healthier food option may contain a fruit juice. The fruit juice may be apple juice, orange juice, grapefruit juice, pear juice, grape juice, tomato juice, peach juice, mango juice, passion fruit juice, prune juice, or the like. The healthier food option may contain a juice that is a blend of fruit and vegetable juices.

In some aspects of the present disclosure, the healthier food option may contain a serving of lean meat. A lean meat may be chicken, turkey, Cornish hen, beef, pork, lamb, buffalo, emu, ostrich, fish, or shellfish.

In some aspects of the present disclosure, the healthier food option may contain at least 10% of the total calories coming from protein. At least 12%, at least 15%, or at least 20% of the calories in the healthier food option may come from protein. The protein source may be fish, chicken, beef, pork, tofu, nuts, or beans.

In some aspects of the present disclosure, the healthier food option may contain at least a fruit, a vegetable, a source of lean protein, and a source of whole grains. The healthier food option may further include a low-fat dairy option.

In an aspect according to the present disclosure, a customer may add value to an online user account by logging into a user account and entering information provided by a receipt or a reward code provided by a loyalty card. In some aspects, 1, 2, 3, 4, 5, 6, 7, 8, 9, 10, 11, 12, 13, 14, or 15 or more receipts or reward codes are entered to accumulate reward account value. In an aspect, a customer may add value to an online user account by scanning a receipt or a code provided by a loyalty card with a smart phone, tablet computer, or other mobile device. The value may be in the form of points, virtual currency, or a dollar amount. The reward code may be associated with a value only after the customer enters the reward code into the online reward system where the online reward system may be accessed by logging into a user account through a web portal. In an aspect, a reward code may only be entered into the online reward system once.

In one aspect of the present disclosure, for purchasers who have no access to a web portal, for example, an alternative may be provided wherein the purchaser returns the receipt or loyalty card by mail or by text, for example.

In one aspect, the present disclosures also provide a method of redeeming a loyalty account value for a reward comprising logging into a user account, accessing an online redemption center, and selecting a prize. The loyalty account value may be in the form of points, virtual currency, or a dollar amount. The user account can be accessed through a web portal associated with a loyalty program. The loyalty account value may increase following entry of the information provided on a receipt as described above or a reward code provided by a loyalty card. Further, the loyalty account value may decrease upon redemption of a reward.

In one aspect, a customer/user may redeem a reward by entering an online reward system by logging into a personal user account. Logging into the user account may take the customer/user to a landing page or a section of an app providing several options including but not limited to options to enter a the information provided on a receipt as described above or a reward code provided by a loyalty card, edit account details, or redeem rewards. The user may select the option to redeem awards and enter another landing page or section providing one or more options including an online catalog. The online catalog may provide a selection of rewards that may be redeemed by the user. In one aspect, the online catalog may display the number of points required to redeem an award. In another aspect, the online catalog may display the amount of virtual currency required to redeem an award. In yet another aspect, the online catalog may display the dollar amount required to redeem an award. The online catalog may provide rewards available for redemption displayed by value, by type (for example, music, food, movie pass, etc.), or by partner or participating rewards vendor. A customer/user may select a reward and the appropriate value is deducted from the customer/user's loyalty account. The reward may be a gift card, prepaid credit card, or prepaid debit card.

What is claimed is:

1. A system for incentivizing a customer to purchase a healthier food item comprising:
a. providing a receipt or one or more loyalty cards;
b. a database for storing customer accounts and point values; and
c. a web portal allowing customers to access and update accounts.

2. The system of claim 1, further comprising an online redemption site.

3. The system of claim 2, wherein said online redemption site may be accessed through said web portal.

4. The system of claim 3, wherein said web portal is accessed through a web app on a smart phone, tablet computer, or other mobile device.

5. The system of claim 1, wherein said receipt or said loyalty cards comprise a reward code.

6. The system of claim 2, wherein said reward code corresponds to an amount of points, virtual currency, or dollar amount.

7. The system of claim 1, wherein said web portal provides access to an online redemption center.

8. The system of claim 7, wherein said online redemption center provides an online catalog of rewards that may be redeemed by said customer with said point values.

9. The system of claim 1, wherein said point values are redeemed for a gift card or a prize.

10. The system of claim 9, wherein said gift card is a prepaid credit card or prepaid debit card.

11. A method of acquiring value in a loyalty program comprising:
a. purchasing a qualified item from a participating vendor;
b. obtaining a receipt comprising information or loyalty card comprising a code;
c. creating an online user account;
d. accessing said online user account; and
e. entering said information or said code.

12. The method of claim 11, wherein said entering comprises capturing an image of said receipt and submitting said image for validation by logging into a user account and uploading said image through a web portal.

13. The method of claim 11, wherein said entering comprises scanning said receipt using a mobile app.

14. The method of claim 11, wherein said value is in the form of points, virtual currency, or a dollar amount.

15. The method of claim 11, wherein said qualified item is a healthier food option.

16. The method of claim 11, further comprising repeating steps a, b, d, and eat least one, two, three or more, five or more, or ten or more times.

17. The method of claim 11, further comprising redeeming said value for a gift card or a prize.

18. The method of claim 17, wherein said gift card is a virtual card.

19. The method of claim 18, wherein said virtual card is a prepaid gift card.

20. The method of claim 11, wherein said participating vendor is a consumer packaged goods company, grocery store, convenience store, department store, market, supermarket, deli, delicatessen, produce market, greengrocer, restaurant, fast-food restaurant, food truck, or the like.

21. The method of claim 11, wherein the said value expires after remaining a constant value for a fixed number of days.

22. The method of claim 15, wherein said value obtained is related to the number of servings of fruit, vegetables, or fruit and vegetables per serving of said healthier food option.

23. The method of claim 15, wherein said value obtained is related to the amount of calories per serving in said healthier food option.

24. The method of claim 15, wherein said value obtained is related to the amount of sodium per serving in said healthier food option.

25. The method of claim 15, wherein said value obtained is related to the amount of saturated fat per serving in said healthier food option.

26. The method of claim 15, wherein said value obtained is related to the amount of cholesterol per serving in said healthier food option.

27. The method of claim 15, wherein said healthier food option is a kid's meal.

28. The method of claim 15, wherein said healthier food option comprises at least one fruit, or at least one vegetable per serving.

29. The method of claim 15, wherein said healthier food option contains less than 500, less than 400, or less than 300 calories per serving.

30. The method of claim 15, wherein said healthier food option contains less than 750 mg, less than 600 mg, less than 500 mg, less than 400 mg, less than 300 mg, less than 200 mg, or less than 100 mg of sodium per serving.

31. The method of claim 15, wherein said healthier food option contains less than 15 grams, less than 10 grams, less than 5 grams, or substantially no saturated fat.

32. The method of claim 15, wherein said healthier food option contains less than 100 mg, less than 75 mg, less than 50 mg, less than 10 mg, or substantially no cholesterol per serving.

33. The method of claim 15, wherein said healthier food option contains less than 1 mg trans fats.

34. The method of claim 15, wherein said healthier food option contains at least a fruit, a vegetable, a source of lean protein, a source of whole grains, and a low-fat dairy option.

35. The method of claim 15, wherein said healthier food option contains less than 35% of the total calories coming from fat, less than 0.5 mg trans fat, and less than 640 mg sodium.

36. The method of claim 15, wherein said healthier food option contains at least 2, 3, 4, 5, 6, 7, 8 or more grams of dietary fiber per serving.

37. A method of accumulating virtual currency that can be used to redeem a gift card or a prize from a merchant comprising:
a. purchasing a healthier food option from a participating vendor;
b. obtaining a receipt comprising information or a reward card comprising a reward code;
c. entering said information or said reward code at an online redemption site; and
d. accumulating virtual currency.

38. The method of claim 37, wherein said entering comprises capturing an image of said receipt and submitting said image for validation by logging into a user account and uploading said image through a web portal.

39. The method of claim 37, wherein said entering comprises scanning said receipt using a mobile app.

40. A method of redeeming points obtained in a loyalty program comprising:
a. accessing an online account;
b. selecting an item to acquire; and
c. redeeming points for the selected item.

41. A method of redeeming a loyalty account value for a reward comprising:
a. logging into a user account;
b. accessing an online redemption center; and
c. selecting a reward,
wherein said user account and said online redemption center are associated with a loyalty program.

42. The method of claim 41, wherein said reward is a prepaid gift card.

43. A method of incentivizing a customer to purchase a healthier food item comprising:
a. assessing whether a food item selected by said customer is a qualifying healthier food item;
b. determining a value to be associated with said healthier food item, wherein said value is higher for qualifying healthier food items and lower for non-qualified healthier food items; and
c. providing a receipt or one or more loyalty cards to said customer, wherein said receipt or loyalty cards are assigned said value associated with said healthier food item.

44. A method of incentivizing a customer to purchase healthier food items, wherein said customer has received one or more receipts or loyalty cards from one or more food vendors and wherein each such receipt or loyalty card has an associated value comprising:
a. authenticating the customer via a web portal;
b. receiving as an input to the web portal the associated value from one or more receipts or loyalty cards;
c. adding each received associated value to an account associated with the authenticated customer; and
d. storing in a computer database the account associated with the authenticated customer.
